(19) United States
(12) Patent Application Publication
(10) Pub. No.: US 2025/0104707 A1
(43) Pub. Date: Mar. 27, 2025

(54) ARTIFICIAL INTELLIGENCE DEVICE

(71) Applicant: LG ELECTRONICS INC., Seoul (KR)

(72) Inventor: Jonghoon CHAE, Seoul (KR)

(73) Assignee: LG ELECTRONICS INC., Seoul (KR)

(21) Appl. No.: 18/727,636

(22) PCT Filed: Jan. 10, 2022
(86) PCT No.: PCT/KR2022/095006

§ 371 Date: Jul. 9, 2024

(51) Int. Cl. G10L 15/22; G10L 15/18; G10L 15/30

(52) U.S. Cl. CPC G10L 15/22; G10L 15/1815; G10L 2015/223; G10L 2015/225; G10L 15/30

(57) ABSTRACT

An artificial intelligence device according to an embodiment of the present invention comprises a microphone and a processor configured to recognize a wake-up command received through the microphone, receive a first voice command through the microphone after recognition of the wake-up command, and obtain first analysis result information indicating an intention analysis result of the first voice command, and infer a first waiting time, which is a time the artificial intelligence device waits for reception of an additional voice command after the recognition of the wake-up command based on the first analysis result information.

### TECHNICAL FIELD

The present disclosure relates to artificial intelligence devices, and more specifically, to devices that provide voice recognition services.

### BACKGROUND ART

A competition for voice recognition technology, which started from smartphones, is expected to intensify in the home, along with the full-scale spread of the Internet of Things (IoT).

What is especially noteworthy is that the device is an artificial intelligence (AI) device that can give commands and have conversations through voice.

The voice recognition service has a structure that utilizes a huge amount of database to select the optimal answer to the user's question.

The voice search function also converts input voice data into text on a cloud server, analyzes it, and retransmits real-time search results based on the results to the device.

The cloud server has the computing power to classify numerous words into voice data categorized by gender, age, and accent, store them, and process them in real time.

As more voice data is accumulated, voice recognition will become more accurate, reaching a level of human parity.

Conventional voice agents have a fixed recognition waiting time for recognition of additional voice commands after recognition of the wake-up word.

As a result, there are cases where the user's continuous commands are not recognized or unnecessary voices are received and analyzed.

In cases where additional voice commands cannot be recognized, there is a problem in which the voice agent switches to a deactivated state due to fixed recognition waiting state even though the user makes an additional voice command.

Additionally, if the recognition waiting time increases significantly, the problem of malfunction due to unnecessary voice recognition occurs even though user does not issue additional voice commands.

### DISCLOSURE

### Technical Problem

The present disclosure aims to solve the above-mentioned problems and other problems.

The purpose of the present disclosure is to provide an artificial intelligence device to effectively recognize the user's continuous voice commands.

The purpose of the present disclosure is to provide an artificial intelligence device that can change the recognition waiting state for additional voice commands based on analysis of the user's speech command.

The purpose of the present disclosure is to provide an artificial intelligence device that can change the recognition waiting state for additional voice commands in a customized way based on the analysis of the user's speech command.

### Technical Solution

The artificial intelligence device according to an embodiment of the present disclosure comprises a microphone and a processor configured to recognize a wake-up command received through the microphone, receive a first voice command through the microphone after recognition of the wake-up command, and obtain first analysis result information indicating an intention analysis result of the first voice command, and infer a first waiting time, which is a time the artificial intelligence device waits for reception of an additional voice command after the recognition of the wake-up command based on the first analysis result information.

Additional scope of applicability of the present disclosure will become apparent from the detailed description below. However, since various changes and modifications within the scope of the present disclosure may be clearly understood by those skilled in the art, the detailed description and specific embodiments such as preferred embodiments of the present disclosure should be understood as being given only as examples.

### Advantageous Effects

According to an embodiment of the present disclosure, the user can avoid the inconvenience of having to enter the wake-up word twice.

According to an embodiment of the present disclosure, after recognition of the wake-up word, the waiting time for recognition of consecutive voice commands can be changed to suit the user's speech pattern, thereby providing an optimized waiting time to the user.

### DESCRIPTION OF DRAWINGS

FIG. 1 is a view illustrating a speech system according to an embodiment of the present disclosure.

FIG. 2 is a block diagram illustrating a configuration of an AI device 10 according to an embodiment of the present disclosure.

FIG. 3A is a block diagram illustrating the configuration of a voice service server according to an embodiment of the present disclosure.

FIG. 3B is a view illustrating that a voice signal is converted into a power spectrum according to an embodiment of the present disclosure.

FIG. 4 is a block diagram illustrating a configuration of a processor for recognizing and synthesizing a voice in an AI device according to an embodiment of the present disclosure.

FIGS. 5 and 6 are diagrams to explain the problem that occurs when the waiting time for the voice agent to recognize the operation command is fixed after recognizing the wake-up word uttered by the user.

FIG. 7 is a flow chart to explain the operation method of an artificial intelligence device according to an embodiment of the present disclosure.

FIGS. 8 to 10 are diagrams explaining the process of inferring waiting time based on command hierarchy information according to an embodiment of the present disclosure.

FIG. 11 is a diagram illustrating the process of obtaining correlation between nodes corresponding to voice commands according to an embodiment of the present disclosure.

FIG. 12 is a diagram illustrating a scenario in which the waiting time for a voice agent to recognize an operation command is increased after recognition of a wake-up word uttered by a user according to an embodiment of the present disclosure.

### BEST MODE

Hereinafter, embodiments are described in more detail with reference to accompanying drawings and regardless of the drawings symbols, same or similar components are assigned with the same reference numerals and thus repetitive for those are omitted. Since the suffixes “module” and “unit” for components used in the following description are given and interchanged for easiness in making the present disclosure, they do not have distinct meanings or functions. In the following description, detailed descriptions of well-known functions or constructions will be omitted because they would obscure the inventive concept in unnecessary detail. Also, the accompanying drawings are used to help easily understanding embodiments disclosed herein but the technical idea of the inventive concept is not limited thereto. It should be understood that all of variations, equivalents or substitutes contained in the concept and technical scope of the present disclosure are also included.

Although the terms including an ordinal number, such as “first” and “second”, are used to describe various components, the components are not limited to the terms. The terms are used to distinguish between one component and another component.

It will be understood that when a component is referred to as being coupled with/to” or “connected to” another component, the component may be directly coupled with/to or connected to the another component or an intervening component may be present therebetween. Meanwhile, it will be understood that when a component is referred to as being directly coupled with/to” or “connected to” another component, an intervening component may be absent therebetween.

An artificial intelligence (AI) device illustrated according to the present disclosure may include a cellular phone, a smart phone, a laptop computer, a digital broadcasting AI device, a personal digital assistants (PDA), a portable multimedia player (PMP), a navigation system, a slate personal computer (PC), a table PC, an ultrabook, a wearable device (for example, a watch-type AI device (smartwatch), a glass-type AI device (a smart glass), or a head mounted display (HMD)), but is not limited thereto.

For instance, an artificial intelligence device 10 may be applied to a stationary-type AI device such as a smart TV, a desktop computer, a digital signage, a refrigerator, a washing machine, an air conditioner, or a dish washer.

In addition, the AI device 10 may be applied even to a stationary robot or a movable robot.

In addition, the AI device 10 may perform the function of a speech agent. The speech agent may be a program for recognizing the voice of a user and for outputting a response suitable for the recognized voice of the user, in the form of a voice.

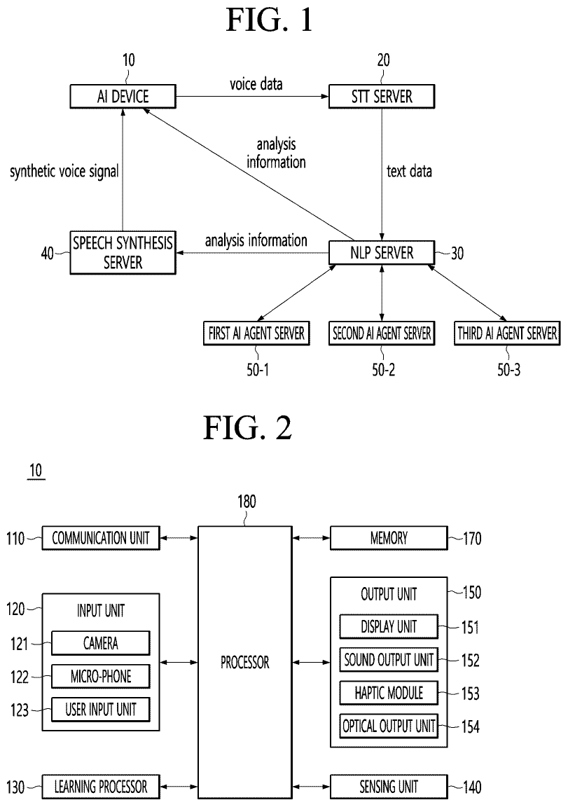

FIG. 1 is a view illustrating a speech system according to an embodiment of the present disclosure.

A typical process of recognizing and synthesizing a voice may include converting speaker voice data into text data, analyzing a speaker intention based on the converted text data, converting the text data corresponding to the analyzed intention into synthetic voice data, and outputting the converted synthetic voice data. As shown in FIG. 1, a speech recognition system 1 may be used for the process of recognizing and synthesizing a voice.

Referring to FIG. 1, the speech recognition system 1 may include the AI device 10, a Speech-To-Text (STT) server 20, a Natural Language Processing (NLP) server 30, a speech synthesis server 40, and a plurality of AI agent servers 50-1 to 50-3.

The AI device 10 may transmit, to the STT server 20, a voice signal corresponding to the voice of a speaker received through a micro-phone 122.

The STT server 20 may convert voice data received from the AI device 10 into text data.

The STT server 20 may increase the accuracy of voice-text conversion by using a language model.

A language model may refer to a model for calculating the probability of a sentence or the probability of a next word coming out when previous words are given.

For example, the language model may include probabilistic language models, such as a Unigram model, a Bigram model, or an N-gram model.

The Unigram model is a model formed on the assumption that all words are completely independently utilized, and obtained by calculating the probability of a row of words by the probability of each word.

The Bigram model is a model formed on the assumption that a word is utilized dependently on one previous word.

The N-gram model is a model formed on the assumption that a word is utilized dependently on (n−1) number of previous words.

In other words, the STT server 20 may determine whether the text data is appropriately converted from the voice data, based on the language model. Accordingly, the accuracy of the conversion to the text data may be enhanced.

The NLP server 30 may receive the text data from the STT server 20. The STT server 20 may be included in the NLP server 30.

The NLP server 30 may analyze text data intention, based on the received text data.

The NLP server 30 may transmit intention analysis information indicating a result obtained by analyzing the text data intention, to the AI device 10.

For another example, the NLP server 30 may transmit the intention analysis information to the speech synthesis server 40. The speech synthesis server 40 may generate a synthetic voice based on the intention analysis information, and may transmit the generated synthetic voice to the AI device 10.

The NLP server 30 may generate the intention analysis information by sequentially performing the steps of analyzing a morpheme, of parsing, of analyzing a speech-act, and of processing a conversation, with respect to the text data.

The step of analyzing the morpheme is to classify text data corresponding to a voice uttered by a user into morpheme units, which are the smallest units of meaning, and to determine the word class of the classified morpheme.

The step of the parsing is to divide the text data into noun phrases, verb phrases, and adjective phrases by using the result from the step of analyzing the morpheme and to determine the relationship between the divided phrases.

The subjects, the objects, and the modifiers of the voice uttered by the user may be determined through the step of the parsing.

The step of analyzing the speech-act is to analyze the intention of the voice uttered by the user using the result from the step of the parsing. Specifically, the step of analyzing the speech-act is to determine the intention of a sentence, for example, whether the user is asking a question, requesting, or expressing a simple emotion.

The step of processing the conversation is to determine whether to make an answer to the speech of the user, make a response to the speech of the user, and ask a question for additional information, by using the result from the step of analyzing the speech-act.

After the step of processing the conversation, the NLP server 30 may generate intention analysis information including at least one of an answer to an intention uttered by the user, a response to the intention uttered by the user, or an additional information inquiry for an intention uttered by the user.

The NLP server 30 may transmit a retrieving request to a retrieving server (not shown) and may receive retrieving information corresponding to the retrieving request, to retrieve information corresponding to the intention uttered by the user.

When the intention uttered by the user is present in retrieving content, the retrieving information may include information on the content to be retrieved.

The NLP server 30 may transmit retrieving information to the AI device 10, and the AI device 10 may output the retrieving information.

Meanwhile, the NLP server 30 may receive text data from the AI device 10. For example, when the AI device 10 supports a voice text conversion function, the AI device 10 may convert the voice data into text data, and transmit the converted text data to the NLP server 30.

The speech synthesis server 40 may generate a synthetic voice by combining voice data which is previously stored.

The speech synthesis server 40 may record a voice of one person selected as a model and divide the recorded voice in the unit of a syllable or a word.

The speech synthesis server 40 may store the voice divided in the unit of a syllable or a word into an internal database or an external database.

The speech synthesis server 40 may retrieve, from the database, a syllable or a word corresponding to the given text data, may synthesize the combination of the retrieved syllables or words, and may generate a synthetic voice. The speech synthesis server 40 may store a plurality of voice language groups corresponding to each of a plurality of languages.

For example, the speech synthesis server 40 may include a first voice language group recorded in Korean and a second voice language group recorded in English.

The speech synthesis server 40 may translate text data in the first language into a text in the second language and generate a synthetic voice corresponding to the translated text in the second language, by using a second voice language group.

The speech synthesis server 40 may transmit the generated synthetic voice to the AI device 10.

The speech synthesis server 40 may receive analysis information from the NLP server 30. The analysis information may include information obtained by analyzing the intention of the voice uttered by the user.

The speech synthesis server 40 may generate a synthetic voice in which a user intention is reflected, based on the analysis information.

According to an embodiment, the STT server 20, the NLP server 30, and the speech synthesis server 40 may be implemented in the form of one server.

The functions of each of the STT server 20, the NLP server 30, and the speech synthesis server 40 described above may be performed in the AI device 10. To this end, the AI device 10 may include at least one processor.

Each of a plurality of AI agent servers 50-1 to 50-3 may transmit the retrieving information to the NLP server 30 or the AI device 10 in response to a request by the NLP server 30.

When intention analysis result of the NLP server 30 corresponds to a request (content retrieving request) for retrieving content, the NLP server 30 may transmit the content retrieving request to at least one of a plurality of AI agent servers 50-1 to 50-3, and may receive a result (the retrieving result of content) obtained by retrieving content, from the corresponding server.

The NLP server 30 may transmit the received retrieving result to the AI device 10.

FIG. 2 is a block diagram illustrating a configuration of an AI device 10 according to an embodiment of the present disclosure.

Referring to FIG. 2, the AI device 10 may include a communication unit 110, an input unit 120, a learning processor 130, a sensing unit 140, an output unit 150, a memory 170, and a processor 180.

The communication unit 110 may transmit and receive data to and from external devices through wired and wireless communication technologies. For example, the communication unit 110 may transmit and receive sensor information, a user input, a learning model, and a control signal to and from external devices.

In this case, communication technologies used by the communication unit 110 include Global System for Mobile Communication (GSM), Code Division Multi Access (CDMA), Long Term Evolution (LTE), 5G (Generation), Wireless LAN (WLAN), Wireless-Fidelity (Wi-Fi), Bluetooth™, RFID (NFC), Infrared Data Association (IrDA), ZigBee, and Near Field Communication (NFC).

The input unit 120 may acquire various types of data.

The input unit 120 may include a camera to input a video signal, a microphone to receive an audio signal, or a user input unit to receive information from a user. In this case, when the camera or the microphone is treated as a sensor, the signal obtained from the camera or the microphone may be referred to as sensing data or sensor information.

The input unit 120 may acquire input data to be used when acquiring an output by using learning data and a learning model for training a model. The input unit 120 may acquire unprocessed input data. In this case, the processor 180 or the learning processor 130 may extract an input feature for pre-processing for the input data.

The input unit 120 may include a camera 121 to input a video signal, a micro-phone 122 to receive an audio signal, and a user input unit 123 to receive information from a user.

Voice data or image data collected by the input unit 120 may be analyzed and processed using a control command of the user.

The input unit 120, which inputs image information (or a signal), audio information (or a signal), data, or information input from a user, may include one camera or a plurality of cameras 121 to input image information, in the AI device 10.

The camera 121 may process an image frame, such as a still image or a moving picture image, which is obtained by an image sensor in a video call mode or a photographing mode. The processed image frame may be displayed on the display unit 151 or stored in the memory 170.

The micro-phone 122 processes an external sound signal as electrical voice data. The processed voice data may be variously utilized based on a function (or an application program which is executed) being performed by the AI device 10. Meanwhile, various noise cancellation algorithms may be applied to the microphone 122 to remove noise caused in a process of receiving an external sound signal.

The user input unit 123 receives information from the user. When information is input through the user input unit 123, the processor 180 may control the operation of the AI device 10 to correspond to the input information.

The user input unit 123 may include a mechanical input unit (or a mechanical key, for example, a button positioned at a front/rear surface or a side surface of the terminal 100, a dome switch, a jog wheel, or a jog switch), and a touch-type input unit. For example, the touch-type input unit may include a virtual key, a soft key, or a visual key displayed on the touch screen through software processing, or a touch key disposed in a part other than the touch screen.

The learning processor 130 may train a model formed based on an artificial neural network by using learning data. The trained artificial neural network may be referred to as a learning model. The learning model may be used to infer a result value for new input data, rather than learning data, and the inferred values may be used as a basis for the determination to perform any action.

The learning processor 130 may include a memory integrated with or implemented in the AI device 10. Alternatively, the learning processor 130 may be implemented using an external memory directly connected to the memory 170 and the AI device or a memory retained in an external device.

The sensing unit 140 may acquire at least one of internal information of the AI device 10, surrounding environment information of the AI device 10, or user information of the AI device 10, by using various sensors.

In this case, sensors included in the sensing unit 140 include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a Lidar or a radar.

The output unit 150 may generate an output related to vision, hearing, or touch.

The output unit 150 may include at least one of a display unit 151, a sound output unit 152, a haptic module 153, or an optical output unit 154.

The display unit 151 displays (or outputs) information processed by the AI device 10. For example, the display unit 151 may display execution screen information of an application program driven by the AI device 10, or a User interface (UI) and graphical User Interface (GUI) information based on the execution screen information.

As the display unit 151 forms a mutual layer structure together with a touch sensor or is integrally formed with the touch sensor, the touch screen may be implemented. The touch screen may function as the user input unit 123 providing an input interface between the AI device 10 and the user, and may provide an output interface between a terminal 100 and the user.

The sound output unit 152 may output audio data received from the communication unit 110 or stored in the memory 170 in a call signal reception mode, a call mode, a recording mode, a voice recognition mode, and a broadcast receiving mode.

The sound output unit 152 may include at least one of a receiver, a speaker, or a buzzer.

The haptic module 153 generates various tactile effects which the user may feel. A representative tactile effect generated by the haptic module 153 may be vibration.

The light outputting unit 154 outputs a signal for notifying that an event occurs, by using light from a light source of the AI device 10. Events occurring in the AI device 10 may include message reception, call signal reception, a missed call, an alarm, schedule notification, email reception, and reception of information through an application.

The memory 170 may store data for supporting various functions of the AI device 10. For example, the memory 170 may store input data, learning data, a learning model, and a learning history acquired by the input unit 120.

The processor 180 may determine at least one executable operation of the AI device 10, based on information determined or generated using a data analysis algorithm or a machine learning algorithm. In addition, the processor 180 may perform an operation determined by controlling components of the AI device 10.

The processor 180 may request, retrieve, receive, or utilize data of the learning processor 130 or data stored in the memory 170, and may control components of the AI device 10 to execute a predicted operation or an operation, which is determined as preferred, of the at least one executable operation.

When the connection of the external device is required to perform the determined operation, the processor 180 may generate a control signal for controlling the relevant external device and transmit the generated control signal to the relevant external device.

The processor 180 may acquire intention information from the user input and determine a request of the user, based on the acquired intention information.

The processor 180 may acquire intention information corresponding to the user input by using at least one of an STT engine to convert a voice input into a character string or an NLP engine to acquire intention information of a natural language.

At least one of the STT engine or the NLP engine may at least partially include an artificial neural network trained based on a machine learning algorithm. In addition, at least one of the STT engine and the NLP engine may be trained by the learning processor 130, by the learning processor 240 of the AI server 200, or by distributed processing into the learning processor 130 and the learning processor 240.

The processor 180 may collect history information including the details of an operation of the AI device 10 or a user feedback on the operation, store the collected history information in the memory 170 or the learning processor 130, or transmit the collected history information to an external device such as the AI server 200. The collected history information may be used to update the learning model.

The processor 180 may control at least some of the components of the AI device 10 to run an application program stored in the memory 170. Furthermore, the processor 180 may combine at least two of the components, which are included in the AI device 10, and operate the combined components, to run the application program.

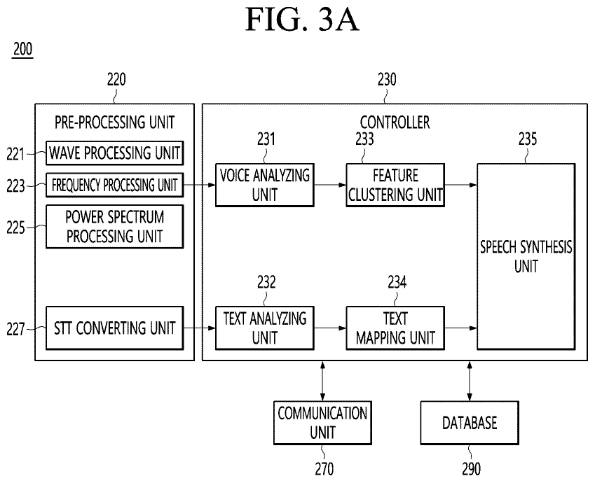

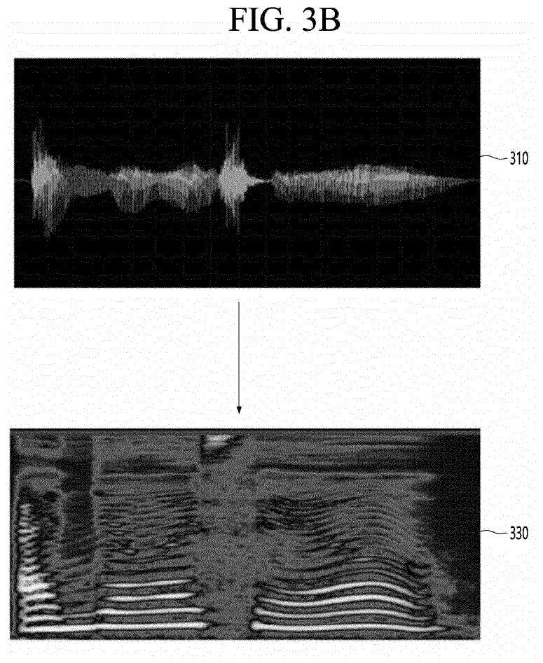

FIG. 3A is a block diagram illustrating the configuration of a voice service server according to an embodiment of the present disclosure.

The speech service server 200 may include at least one of the STT server 20, the NLP server 30, or the speech synthesis server 40 illustrated in FIG. 1. The speech service server 200 may be referred to as a server system.

Referring to FIG. 3A, the speech service server 200 may include a pre-processing unit 220, a controller 230, a communication unit 270, and a database 290.

The pre-processing unit 220 may pre-process the voice received through the communication unit 270 or the voice stored in the database 290.

The pre-processing unit 220 may be implemented as a chip separate from the controller 230, or as a chip included in the controller 230.

The pre-processing unit 220 may receive a voice signal (which the user utters) and filter out a noise signal from the voice signal, before converting the received voice signal into text data.

When the pre-processing unit 220 is provided in the AI device 10, the pre-processing unit 220 may recognize a wake-up word for activating voice recognition of the AI device 10. The pre-processing unit 220 may convert the wake-up word received through the micro-phone 121 into text data. When the converted text data is text data corresponding to the wake-up word previously stored, the pre-processing unit 220 may make a determination that the wake-up word is recognized.

The pre-processing unit 220 may convert the noise-removed voice signal into a power spectrum.

The power spectrum may be a parameter indicating the type of a frequency component and the size of a frequency included in a waveform of a voice signal temporarily fluctuating.

The power spectrum shows the distribution of amplitude square values as a function of the frequency in the waveform of the voice signal. The details thereof be described with reference to FIG. 3B later.

FIG. 3B is a view illustrating that a voice signal is converted into a power spectrum according to an embodiment of the present disclosure.

Referring to FIG. 3B, a voice signal 310 is illustrated. The voice signal 210 may be a signal received from an external device or previously stored in the memory 170.

An x-axis of the voice signal 310 may indicate time, and the y-axis may indicate the magnitude of the amplitude.

The power spectrum processing unit 225 may convert the voice signal 310 having an x-axis as a time axis into a power spectrum 330 having an x-axis as a frequency axis.

The power spectrum processing unit 225 may convert the voice signal 310 into the power spectrum 330 by using fast Fourier Transform (FFT).

The x-axis and the y-axis of the power spectrum 330 represent a frequency, and a square value of the amplitude.

FIG. 3A will be described again.

The functions of the pre-processing unit 220 and the controller 230 described in FIG. 3A may be performed in the NLP server 30.

The pre-processing unit 220 may include a wave processing unit 221, a frequency processing unit 223, a power spectrum processing unit 225, and a STT converting unit 227.

The wave processing unit 221 may extract a waveform from a voice.

The frequency processing unit 223 may extract a frequency band from the voice.

The power spectrum processing unit 225 may extract a power spectrum from the voice.

The power spectrum may be a parameter indicating a frequency component and the size of the frequency component included in a waveform temporarily fluctuating, when the waveform temporarily fluctuating is provided.

The STT converting unit 227 may convert a voice into a text.

The STT converting unit 227 may convert a voice made in a specific language into a text made in a relevant language.

The controller 230 may control the overall operation of the speech service server 200.

The controller 230 may include a voice analyzing unit 231, a text analyzing unit 232, a feature clustering unit 233, a text mapping unit 234, and a speech synthesis unit 235.

The voice analyzing unit 231 may extract characteristic information of a voice by using at least one of a voice waveform, a voice frequency band, or a voice power spectrum which is pre-processed by the pre-processing unit 220.

The characteristic information of the voice may include at least one of information on the gender of a speaker, a voice (or tone) of the speaker, a sound pitch, the intonation of the speaker, a speech rate of the speaker, or the emotion of the speaker.

In addition, the characteristic information of the voice may further include the tone of the speaker.

The text analyzing unit 232 may extract a main expression phrase from the text converted by the STT converting unit 227.

When detecting that the tone is changed between phrases, from the converted text, the text analyzing unit 232 may extract the phrase having the different tone as the main expression phrase.

When a frequency band is changed to a preset band or more between the phrases, the text analyzing unit 232 may determine that the tone is changed.

The text analyzing unit 232 may extract a main word from the phrase of the converted text. The main word may be a noun which exists in a phrase, but the noun is provided only for the illustrative purpose.

The feature clustering unit 233 may classify a speech type of the speaker using the characteristic information of the voice extracted by the voice analyzing unit 231.

The feature clustering unit 233 may classify the speech type of the speaker, by placing a weight to each of type items constituting the characteristic information of the voice.

The feature clustering unit 233 may classify the speech type of the speaker, using an attention technique of the deep learning model.

The text mapping unit 234 may translate the text converted in the first language into the text in the second language.

The text mapping unit 234 may map the text translated in the second language to the text in the first language.

The text mapping unit 234 may map the main expression phrase constituting the text in the first language to the phrase of the second language corresponding to the main expression phrase.

The text mapping unit 234 may map the speech type corresponding to the main expression phrase constituting the text in the first language to the phrase in the second language. This is to apply the speech type, which is classified, to the phrase in the second language.

The speech synthesis unit 235 may generate the synthetic voice by applying the speech type, which is classified in the feature clustering unit 233, and the tone of the speaker to the main expression phrase of the text translated in the second language by the text mapping unit 234.

The controller 230 may determine a speech feature of the user by using at least one of the transmitted text data or the power spectrum 330.

The speech feature of the user may include the gender of a user, the pitch of a sound of the user, the sound tone of the user, the topic uttered by the user, the speech rate of the user, and the voice volume of the user.

The controller 230 may obtain a frequency of the voice signal 310 and an amplitude corresponding to the frequency using the power spectrum 330.

The controller 230 may determine the gender of the user who utters the voice, by using the frequency band of the power spectrum 230.

For example, when the frequency band of the power spectrum 330 is within a preset first frequency band range, the controller 230 may determine the gender of the user as a male.

When the frequency band of the power spectrum 330 is within a preset second frequency band range, the controller 230 may determine the gender of the user as a female. In this case, the second frequency band range may be greater than the first frequency band range.

The controller 230 may determine the pitch of the voice, by using the frequency band of the power spectrum 330.

For example, the controller 230 may determine the pitch of a sound, based on the magnitude of the amplitude, within a specific frequency band range.

The controller 230 may determine the tone of the user by using the frequency band of the power spectrum 330. For example, the controller 230 may determine, as a main sound band of a user, a frequency band having at least a specific magnitude in an amplitude, and may determine the determined main sound band as a tone of the user.

The controller 230 may determine the speech rate of the user based on the number of syllables uttered per unit time, which are included in the converted text data.

The controller 230 may determine the uttered topic by the user through a Bag-Of-Word Model technique, with respect to the converted text data.

The Bag-Of-Word Model technique is to extract mainly used words based on the frequency of words in sentences. Specifically, the Bag-Of-Word Model technique is to extract unique words within a sentence and to express the frequency of each extracted word as a vector to determine the feature of the uttered topic.

For example, when words such as “running” and “physical strength” frequently appear in the text data, the controller 230 may classify, as exercise, the uttered topic by the user.

The controller 230 may determine the uttered topic by the user from text data using a text categorization technique which is well known. The controller 230 may extract a keyword from the text data to determine the uttered topic by the user.

The controller 230 may determine the voice volume of the user voice, based on amplitude information in the entire frequency band.

For example, the controller 230 may determine the voice volume of the user, based on an amplitude average or a weight average in each frequency band of the power spectrum.

The communication unit 270 may make wired or wireless communication with an external server.

The database 290 may store a voice in a first language, which is included in the content.

The database 290 may store a synthetic voice formed by converting the voice in the first language into the voice in the second language.

The database 290 may store a first text corresponding to the voice in the first language and a second text obtained as the first text is translated into a text in the second language.

The database 290 may store various learning models necessary for speech recognition.

Meanwhile, the processor 180 of the AI device 10 illustrated in FIG. 2 may include the pre-processing unit 220 and the controller 230 illustrated in FIG. 3.

In other words, the processor 180 of the AI device 10 may perform a function of the pre-processing unit 220 and a function of the controller 230.

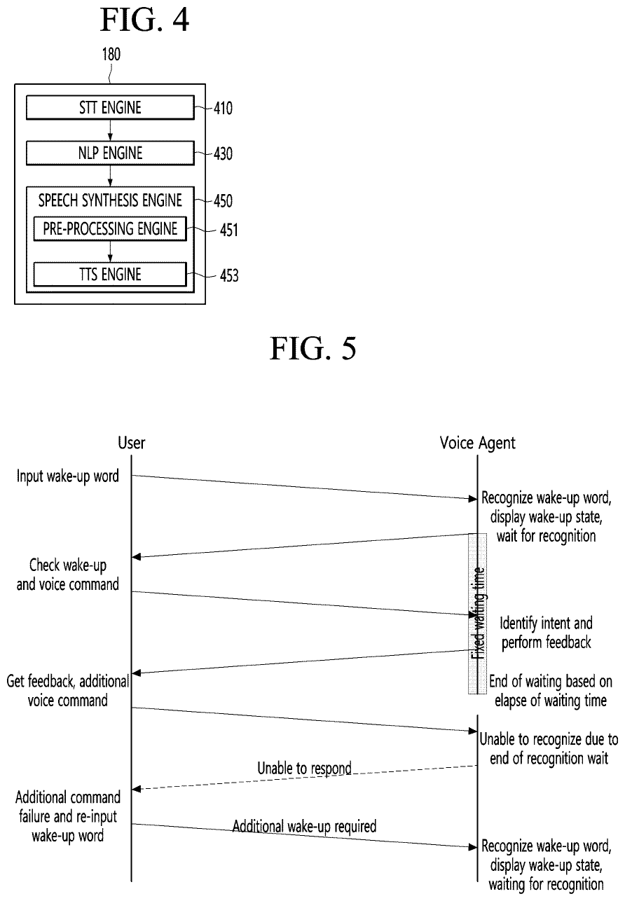

FIG. 4 is a block diagram illustrating a configuration of a processor for recognizing and synthesizing a voice in an AI device according to an embodiment of the present disclosure.

In other words, the processor for recognizing and synthesizing a voice in FIG. 4 may be performed by the learning processor 130 or the processor 180 of the AI device 10, without performed by a server.

Referring to FIG. 4, the processor 180 of the AI device 10 may include an STT engine 410, an NLP engine 430, and a speech synthesis engine 450.

Each engine may be either hardware or software.

The STT engine 410 may perform a function of the STT server 20 of FIG. 1. In other words, the STT engine 410 may convert the voice data into text data.

The NLP engine 430 may perform a function of the NLP server 30 of FIG. 1. In other words, the NLP engine 430 may acquire intention analysis information, which indicates the intention of the speaker, from the converted text data.

The speech synthesis engine 450 may perform the function of the speech synthesis server 40 of FIG. 1.

The speech synthesis engine 450 may retrieve, from the database, syllables or words corresponding to the provided text data, and synthesize the combination of the retrieved syllables or words to generate a synthetic voice.

The speech synthesis engine 450 may include a pre-processing engine 451 and a Text-To-Speech (TTS) engine 453.

The pre-processing engine 451 may pre-process text data before generating the synthetic voice.

Specifically, the pre-processing engine 451 performs tokenization by dividing text data into tokens which are meaningful units.

After the tokenization is performed, the pre-processing engine 451 may perform a cleansing operation of removing unnecessary characters and symbols such that noise is removed.

Thereafter, the pre-processing engine 451 may generate the same word token by integrating word tokens having different expression manners.

Thereafter, the pre-processing engine 451 may remove a meaningless word token (informal word; stopword).

The TTS engine 453 may synthesize a voice corresponding to the preprocessed text data and generate the synthetic voice.

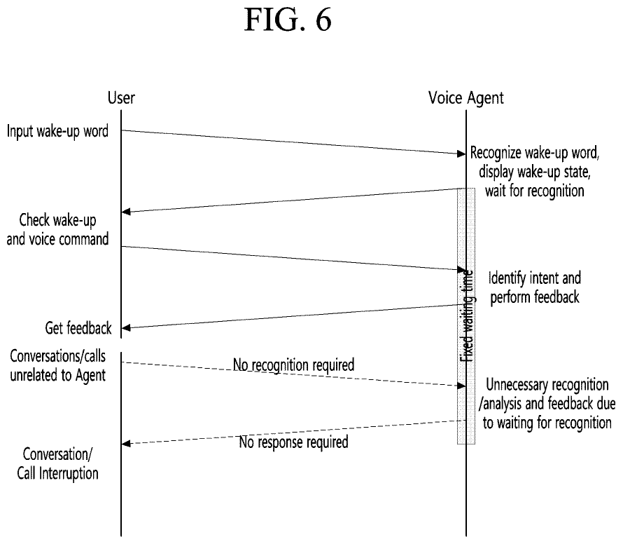

FIGS. 5 and 6 are diagrams to explain the problem that occurs when the waiting time for the voice agent to recognize the operation command is fixed after recognizing the wake-up word uttered by the user.

A voice agent is an electronic device that can provide voice recognition services.

Hereinafter, a waiting time may be a time the voice agent waits to recognize an operation command after recognizing the wake-up command.

The voice agent can enter a state in which the voice recognition service is activated by a wake-up command and perform functions according to intention analysis of the operation command.

After the waiting time has elapsed, the voice agent can again enter a deactivated state that requires recognition of the wake-up word.

In FIGS. 5 and 6, the waiting time is a fixed time.

Referring to FIG. 5, the user utters the wake-up word. The voice agent recognizes the wake-up word and displays the wake-up status. After recognizing the wake-up word, the voice agent waits for recognition of the operation command.

The voice agent is in an activated state capable of recognizing operation commands for a fixed, predetermined waiting time.

The user confirms the activation of the voice agent and utters a voice command, which is an operation command.

The voice agent receives the voice command uttered by the user within a fixed waiting time, determines the intention of the voice command, and outputs feedback based on the identified intention.

If the user utters an additional voice command after the fixed waiting time has elapsed, the voice agent cannot recognize the additional voice command because it has entered a deactivated state.

In this case, the user has the inconvenience of having to recognize the failure of the additional voice command and re-enter the wake-up word to wake up the voice agent. In other words, there is the inconvenience of having to re-enter the wake-up word due to the elapse of the fixed waiting time.

Consider the case where the fixed waiting time is increased from the example in FIG. 5, as in the example in FIG. 6.

In this case, after receiving feedback on the voice command, the user conducts a conversation or call unrelated to the use of the voice agent. Since the fixed waiting time has not elapsed, the voice agent recognizes the content of the conversation or call uttered by the user and outputs feedback about it.

In other words, when the fixed waiting time is increased to solve the problem of FIG. 5, feedback on content of conversation or call unrelated to the voice agent is provided, causing a problem that interferes with the user's conversation or call.

In the embodiment of the present disclosure, it is intended to change the waiting time according to the analysis of the voice command uttered by the user.

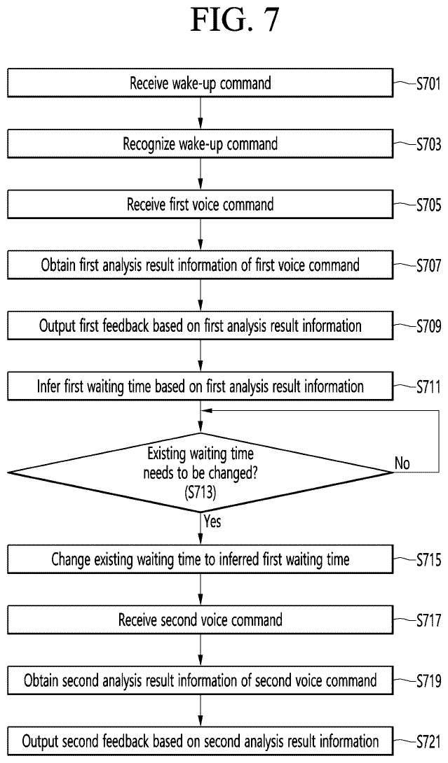

FIG. 7 is a flowchart explaining an operating method of an artificial intelligence device according to an embodiment of the present disclosure.

In particular, FIG. 7 shows an embodiment of changing the waiting time according to the received voice command after recognition of the wake-up command.

Referring to FIG. 7, the processor 180 of the artificial intelligence device 10 receives a wake-up command through the microphone 122 (S701).

The wake-up command may be a voice to activate the voice recognition function of the artificial intelligence device 10.

The processor 180 recognizes the received wake-up command (S703).

The processor 180 may convert voice data corresponding to the wake-up command into text data and determine whether the converted text data matches data corresponding to the wake-up command stored in the memory 170.

If the converted text data matches the stored data, the processor 180 may determine that the wake-up command has been recognized. Accordingly, the processor 180 can activate the voice recognition function of the artificial intelligence device 10.

The processor 180 may activate the voice recognition function for a fixed waiting time. The fixed waiting time can be a user-set time or default time.

The processor 180 may wait to receive a voice corresponding to the operation command according to recognition of the wake-up command.

After recognizing the wake-up command, the processor 180 may output a notification indicating recognition of the wake-up command as a voice through the sound output unit 152 or display 151.

After that, the processor 180 receives a first voice command, which is an operation command, through the microphone 122 (S705).

The first voice command can be received within the waiting time.

The processor 180 obtains first analysis result information through analysis of the first voice command (S707).

In one embodiment, the processor 180 may convert the first voice command into first text using the STT engine 410. The processor 180 may obtain first analysis result information indicating the intent of the first text through the NLP engine 430.

In another embodiment, the processor 180 may transmit a first voice signal corresponding to the first voice command to the NLP server 30 and receive first analysis result information from the NLP server 30.

The first analysis result information may include information reflecting the user's intention, such as searching for specific information and performing a specific function of the artificial intelligence device 10.

The processor 180 outputs first feedback based on the obtained first analysis result information (S709).

The first feedback may be feedback that responds to the user's first voice command based on the first analysis result information.

The processor 180 infers the first waiting time based on the first analysis result information (S711).

In one embodiment, the processor 180 may extract the first intent from the first analysis result information and obtain first command hierarchy information from the extracted first intent.

The processor 180 may calculate the first probability that an additional voice command will be input from the first command hierarchy information and infer the first waiting time based on the calculated first probability.

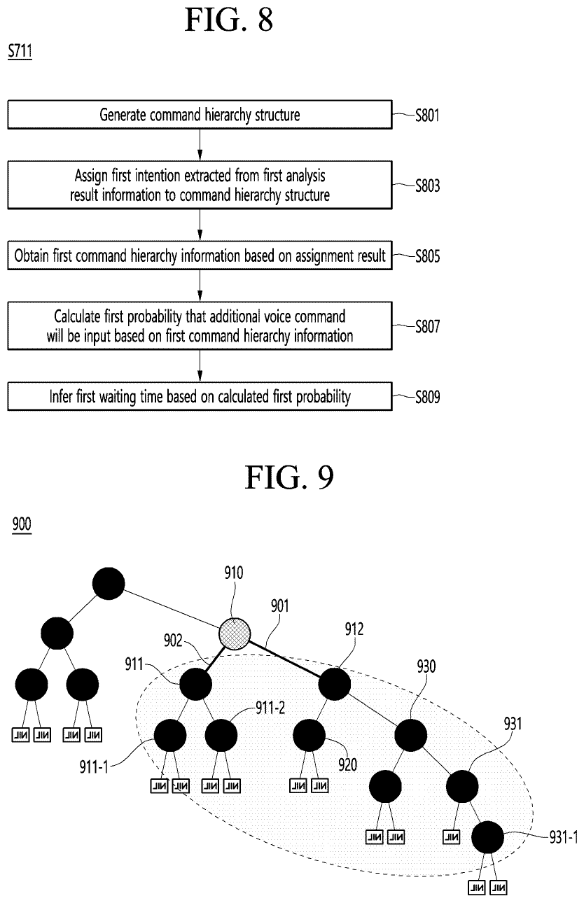

This will be explained with reference to FIG. 8.

FIGS. 8 to 10 are diagrams illustrating a process of inferring waiting time based on command hierarchy information according to an embodiment of the present disclosure.

In particular, FIG. 8 is a diagram illustrating step S711 of FIG. 7 in detail.

The processor 180 of the artificial intelligence device 10 generates a command hierarchy structure (S801).

In one embodiment, the processor 180 may generate a command hierarchy structure based on a large-scale usage pattern log and manufacturer command definitions.

In another embodiment, the artificial intelligence device 10 may receive a command hierarchy structure from the NLP server 30.

A large-scale usage pattern log may include patterns of voice commands used in the voice recognition service of an artificial intelligence device 10.

The manufacturer command definition may refer to a set of voice commands to be used when the manufacturer of the artificial intelligence device 10 provides the voice recognition service of the artificial intelligence device 10.

A command hierarchy structure can be generated by large-scale usage pattern logs and manufacturer command definitions.

FIG. 9 is a diagram explaining the command hierarchy structure according to an embodiment of the present disclosure.

Referring to FIG. 9, a command hierarchy structure 900 is shown showing a plurality of nodes corresponding to each of a plurality of intentions (or a plurality of voice commands) and a hierarchical relationship between the plurality of nodes.

The lines connecting nodes may be edges that indicate the relationship between nodes.

Each node may correspond to a specific voice command or the intent of a specific voice command.

A parent node may include one or more intermediate nodes and one or more child nodes.

For example, the first parent node 910 may have a first intermediate node 911 and a second intermediate node 912.

The first intermediate node 911 may have a first child node 911-1 and a second child node 911-2.

The second intermediate node 912 may have a third child node 911-2 and a fourth child node 930.

Again, FIG. 8 will be described.

The processor 180 assigns the first intention extracted from the first analysis result information to the command hierarchy structure (S803).

The processor 180 may assign the first intention indicated by the first analysis result information to the command hierarchy structure 900.

For example, the first intent may be assigned to the first parent node 910 of the command hierarchy structure 900.

The processor 180 obtains first command hierarchy information based on the assignment result (S805) and calculates a first probability that an additional voice command will be input based on the obtained first command hierarchy information (S807).

The processor 180 may obtain first command hierarchy information using depth information of the assigned node and correlation information between child nodes of the assigned node.

For example, when the first intention is assigned to the first parent node 910, the depth information of the first parent node 910 is information indicating the depth of the first parent node 910, and can be expressed as the number of edges 4 up to the lowest node 931-1.

The correlation between child nodes of an assigned node can be expressed as the weight of the edge.

The processor 180 calculates the sum of the weights assigned to each of the edges from the first parent node 910 to the lowest node 931-1 passing through the nodes 912, 930, and 931. The weight of each edge can be set in proportion to the probability that an additional voice command will be uttered.

The processor 180 may determine the sum of weights assigned to each of the edges up to the lowest node 931-1 as the first probability.

In other words, as the sum of weights assigned to each of the edges up to the lowest node 931-1 increases, the probability that an additional voice command is input also increases. And, as the sum of weights assigned to each of the edges up to the lowest node 931-1 decreases, the probability that an additional voice command is input also decreases.

The processor 180 infers the first waiting time based on the calculated first probability (S711).

As the first probability of uttering an additional voice command increases, the first waiting time may also increase.

The memory 170 may store a lookup table mapping a plurality of waiting times corresponding to each of a plurality of probabilities.

The processor 180 may determine the first waiting time corresponding to the first probability using the lookup table stored in the memory 170.

Again, FIG. 7 will be described.

The processor 180 determines whether the existing waiting time needs to be changed according to a comparison between the inferred first waiting time and the existing waiting time (S713).

The existing waiting time may be the time set in the artificial intelligence device 10 before the first waiting time is inferred.

If the existing waiting time needs to be changed, the processor 180 changes the existing waiting time to the inferred first waiting time (S715).

If the inferred first waiting time is greater than the existing waiting time, the processor 180 may change and set the existing waiting time to the inferred first waiting time.

The processor 180 receives the second voice command in a state that the waiting time is changed to the first waiting time (S715).

The processor 180 receives the second voice command and obtains second analysis result information of the second voice command (S719).

If the second voice command is received within the first waiting time, the processor 180 may obtain second analysis result information for the second voice command.

The processor 180 may obtain second analysis result information using the first analysis result information and the second voice command.

This is because the first voice command and the second voice command are related commands.

The processor 180 outputs a second feedback based on the second analysis result information (S721).

In one embodiment, the processor 180 may convert the second voice command into second text using the STT engine 410. The processor 180 may obtain second analysis result information indicating the intent of the second text through the NLP engine 430.

In another embodiment, the processor 180 may transmit a second voice signal corresponding to the second voice command to the NLP server 30 and receive second analysis result information from the NLP server 30.

The second analysis result information may include information that reflects the user's intention, such as searching for specific information and performing a specific function of the artificial intelligence device 10.

The second analysis result information may be information generated based on the first analysis result information and the second voice command.

In this way, according to the embodiment of the present disclosure, unlike the fixed waiting time, the waiting time can be increased according to the analysis of the voice command uttered by the user, eliminating the inconvenience of entering the wake-up word twice.

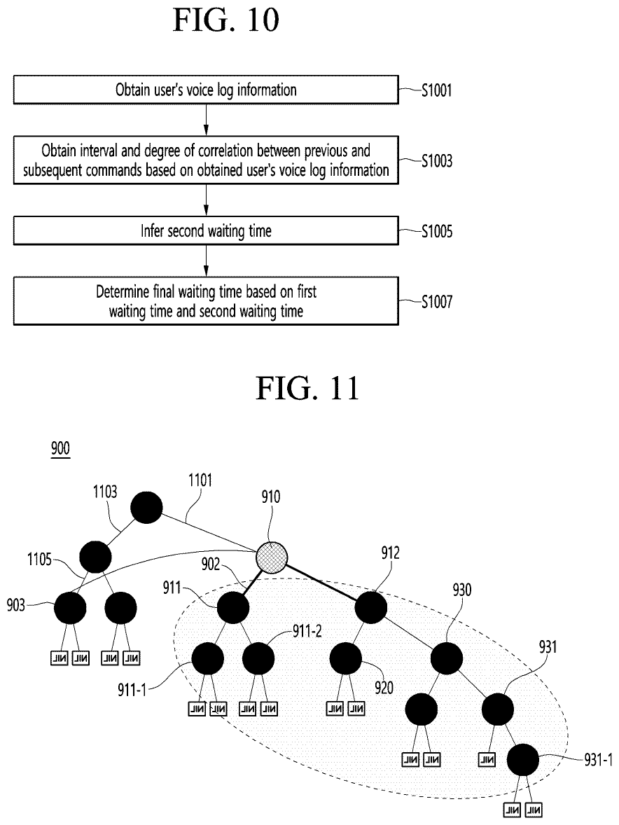

Next, FIG. 10 will be described.

FIG. 10 is a flowchart explaining a method of determining the optimal waiting time according to an embodiment of the present disclosure.

FIG. 10 may be an example performed after step S721 of FIG. 7.

The processor 180 obtains the user's voice log information (S1001).

The user's voice log information may include the first voice command and the second voice command of FIG. 5.

The user's voice log information may further include information on when the second voice command is received after feedback is output according to the first voice command.

The user's voice log information may further include first analysis result information corresponding to the first voice command and second analysis result information corresponding to the second voice command.

The user's voice log information may further include information about the node to which the first voice command is assigned and the node to which the second voice command is assigned in the command hierarchy structure 900.

The processor 180 obtains the interval and degree of correlation between previous and subsequent commands based on the obtained user's voice log information (S1003).

In one embodiment, the processor 180 may measure the interval between continuously input voice commands.

The processor 180 can measure the time taken from the output of the first feedback corresponding to the first voice command to the input of the second voice command, and obtain the measured time as the interval between previous and subsequent commands.

The processor 180 may obtain the distance between the first node corresponding to the first voice command assigned to the command hierarchy structure 900 and the second node corresponding to the second voice command assigned to the command hierarchy structure 900.

This will be explained with reference to FIG. 11.

FIG. 11 is a diagram illustrating a process of obtaining correlation between nodes corresponding to voice commands according to an embodiment of the present disclosure.

The command hierarchy structure 900 shown in FIG. 11 is the same as the example in FIG. 9.

If the first node 910 is assigned to the first voice command and the second node 903 is assigned, the processor 180 may obtain the sum of the weights of the edges 1101, 1103, and 1105 passing from the first node 910 to the second node 903 as the distance between the nodes.

The processor 180 may obtain the value calculated by dividing the sum of the obtained weights by the number of edges as the degree of correlation between nodes.

Again, FIG. 10 will be described.

The processor 180 infers the second waiting time based on the interval and degree of correlation between previous and subsequent instructions (S1005).

The processor 180 may calculate a second probability that an additional voice command will be input using the first normalization value of the interval between preceding and following commands and the second normalization value of degree of correlation.

The first normalization value may be a value obtained by normalizing the interval between preceding and following instructions to a value between 0 and 1, and the second normalization value may be a value normalizing the degree of correlation to a value between 0 and 1.

The processor 180 may obtain the average of the first normalization value and the second normalization value as the second probability.

The processor 180 may extract the second waiting time matching the second probability using the lookup table stored in the memory 170.

The processor 180 determines the final waiting time based on the inferred second waiting time and the first waiting time of step S711 (S1007).

The processor 180 may calculate a first time by applying a first weight to the first waiting time and a second time by applying a second weight to the second waiting time.

The processor 180 may determine the first and second weights based on the first reliability of the inference of the first waiting time and the second reliability of the inference of the second waiting time.

The processor 180 may infer the first reliability based on the location of the node assigned to the first voice command in the command hierarchy structure 900. For example, the processor 180 may increase the first reliability as the node assigned to the first voice command becomes a higher node. As the first reliability increases, the first weight may also increase.

The processor 180 may increase the second reliability as the number of acquisitions of the user's voice log information increases. As the second reliability increases, the second weight may also increase.

The processor 180 may determine the average of the first time and the second time as the final waiting time.

As such, according to the embodiment of the present disclosure, after recognizing the wake-up word, the waiting time for recognition of continuous voice commands is changed to suit the user's speech pattern, thereby providing the user with an optimized waiting time.

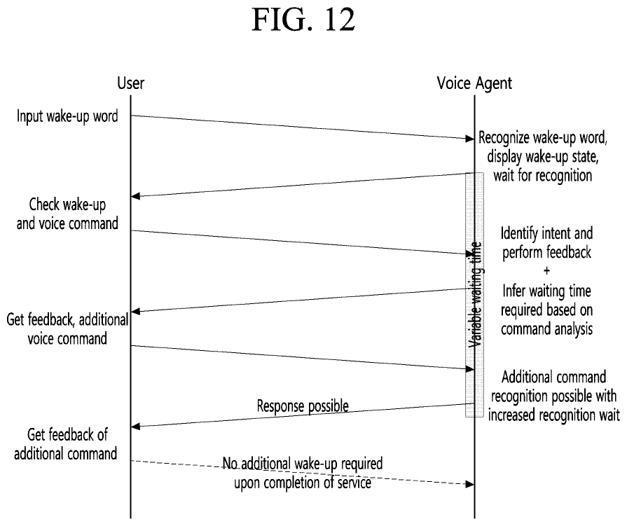

FIG. 12 is a diagram illustrating a scenario in which the waiting time for a voice agent to recognize an operation command is increased after recognition of a wake-up word uttered by a user according to an embodiment of the present disclosure.

The user utters the wake-up word. The voice agent recognizes the wake-up word and displays the wake-up status. After recognizing the wake-up word, the voice agent waits for recognition of the operation command.

The voice agent is in an activated state capable of recognizing operation commands for a fixed, predetermined waiting time.

The user confirms the activation of the voice agent and utters a voice command, which is an operation command.

The voice agent receives the voice command uttered by the user within the waiting time, identifies the intention of the voice command, and outputs feedback based on the identified intention.

At the same time, the voice agent can increase the existing waiting time to a waiting time appropriate for the analysis of voice commands.

The voice agent can recognize additional voice commands with increased waiting time and provide feedback corresponding to the additional voice commands to the user.

Accordingly, the user does not need to additionally utter the wake-up word, and the user experience of the voice recognition service can be greatly improved.

The above-described present invention can be implemented as computer-readable code on a program-recorded medium. Computer-readable medium includes all types of recording devices that store data that can be read by a computer system. Examples of computer-readable medium include HDD (Hard Disk Drive), SSD (Solid State Disk), SDD (Silicon Disk Drive), ROM, RAM, CD-ROM, magnetic tape, floppy disk, optical data storage device, etc. Additionally, the computer may include a processor 180 of an artificial intelligence device.

1. An artificial intelligence device, comprising:
a microphone; and
a processor configured to recognize a wake-up command received through the microphone, receive a first voice command through the microphone after recognition of the wake-up command, and obtain first analysis result information indicating an intention analysis result of the first voice command, and infer a first waiting time, which is a time the artificial intelligence device waits for reception of an additional voice command after the recognition of the wake-up command based on the first analysis result information.

2. The artificial intelligence device according to claim 1, wherein the processor is configured to compare a preset waiting time and the inferred first waiting time, and if the first waiting time is greater, change the preset waiting time to the first waiting time.

3. The artificial intelligence device according to claim 2, wherein the processor is configured to receive a second voice command through the microphone within the first waiting time, and obtain second analysis result information indicating an intention analysis result of the received second voice command.

4. The artificial intelligence device according to claim 3, wherein the processor is configured to:
assign a first intention corresponding to the first analysis result information to a command hierarchy structure indicating a plurality of nodes corresponding to each of a plurality of intentions and a hierarchical relationship between the plurality of nodes, and
calculate a first probability that an additional voice command will be input based on an assignment result, and determine a time corresponding to the calculated first probability as the first waiting time.

5. The artificial intelligence device according to claim 4, further comprising a memory configured to store a lookup table indicating a correspondence between a plurality of probabilities and a plurality of waiting times corresponding to each of the plurality of probabilities, and
the processor is configured to determine a second waiting time matching the first probability using the lookup table.

6. The artificial intelligence device according to claim 4, wherein the processor is configured to:
obtain an interval between commands and degree of correlation based on a user's voice log information including the first voice command and the second voice command, and
infer a second waiting time based on the obtained interval and degree of correlation.

7. The artificial intelligence device according to claim 6, wherein the interval is a time taken from an output of a first feedback corresponding to the first voice command to an input of the second voice command, and
the degree of correlation indicates a distance between a first node corresponding to the first voice command and a second node corresponding to the second voice command in the command hierarchy structure.

8. The artificial intelligence device according to claim 6, wherein the processor is configured to determine a final waiting time based on the first waiting time and the second waiting time.

9. The artificial intelligence device according to claim 6, wherein the processor is configured to apply weights to each of the first waiting time and the second waiting time and determine the final waiting time according to a result of applying the weights.

10. An operating method of an artificial intelligence device, comprising:
receiving a wake-up command;
receiving a first voice command after recognition of the wake-up command;
obtaining first analysis result information indicating an intention analysis result of the first voice command; and
inferring a first waiting time, which is a time the artificial intelligence device waits for reception of an additional voice command after the recognition of the wake-up command based on the first analysis result information.

11. An inactive recording medium storing a computer-readable program for performing an operating method of an artificial intelligence device, the operating method comprising:
receiving a wake-up command;
receiving a first voice command after recognition of the wake-up command;
obtaining first analysis result information indicating an intention analysis result of the first voice command; and
inferring a first waiting time, which is a time the artificial intelligence device waits for reception of an additional voice command after the recognition of the wake-up command based on the first analysis result information.

12. The operating method of an artificial intelligence device according to claim 10, further comprising:
comparing a preset waiting time and the inferred first waiting time, and
if the first waiting time is greater, changing the preset waiting time to the first waiting time.

13. The operating method of an artificial intelligence device according to claim 12, further comprising:
receiving a second voice command through the microphone within the first waiting time, and
obtaining second analysis result information indicating an intention analysis result of the received second voice command.

14. The operating method of an artificial intelligence device according to claim 13, the inference of the first waiting time comprises:
assigning a first intention corresponding to the first analysis result information to a command hierarchy structure indicating a plurality of nodes corresponding to each of a plurality of intentions and a hierarchical relationship between the plurality of nodes,
calculating a first probability that an additional voice command will be input based on an assignment result, and
determining a time corresponding to the calculated first probability as the first waiting time.

15. The operating method of an artificial intelligence device according to claim 14, further comprising:
storing a lookup table indicating a correspondence between a plurality of probabilities and a plurality of waiting times corresponding to each of the plurality of probabilities, and
determining a second waiting time matching the first probability using the lookup table.

16. The operating method of an artificial intelligence device according to claim 14, further comprising:
obtaining an interval between commands and degree of correlation based on a user's voice log information including the first voice command and the second voice command, and
inferring a second waiting time based on the obtained interval and degree of correlation.

17. The operating method of an artificial intelligence device according to claim 16, wherein the interval is a time taken from an output of a first feedback corresponding to the first voice command to an input of the second voice command, and
the degree of correlation indicates a distance between a first node corresponding to the first voice command and a second node corresponding to the second voice command in the command hierarchy structure.

18. The operating method of an artificial intelligence device according to claim 16, further comprising:
determining a final waiting time based on the first waiting time and the second waiting time.

19. The operating method of an artificial intelligence device according to claim 18, further comprising:
applying weights to each of the first waiting time and the second waiting time; and
determining the final waiting time according to a result of applying the weights.

20. The inactive recording medium storing a computer-readable program for performing an operating method of an artificial intelligence device according to claim 11, further comprising:
comparing a preset waiting time and the inferred first waiting time, and
if the first waiting time is greater, changing the preset waiting time to the first waiting time.
